(19) United States
(12) Patent Application Publication
(10) Pub. No.: US 2016/0107422 A1
(43) Pub. Date: Apr. 21, 2016

(54) SHRINK SLEEVE LABEL

(71) Applicant: SEALED AIR CORPORATION (US), Elmwood Park, NJ (US)

(72) Inventor: Larry Bickle McAllister, JR., Spartanburg, SC (US)

(73) Assignee: Sealed Air Corporation (US), Duncan, SC (US)

(21) Appl. No.: 14/892,899

(22) PCT Filed: May 16, 2014
(86) PCT No.: PCT/US14/38397

§ 371 Date: Nov. 20, 2015

Related U.S. Application Data
(60) Provisional application No. 61/825,643, filed on May 21, 2013.

(51) Int. Cl. B32B 25/08; B65C 3/06; B32B 27/30; B32B 1/08; B29C 65/00; B32B 25/16; B32B 27/08; B32B 27/32; B32B 27/28; B29C 47/00; B29C 65/66; B32B 7/02

(52) U.S. Cl. CPC B32B 25/08; B29C 65/66; B65C 3/065; B32B 27/302; B32B 1/08; B32B 7/02; B32B 25/16; B32B 27/08; B32B 27/32; B32B 27/28; B29C 47/0004; B29C 47/0021; B29C 47/0057; B29C 66/53245; B29L 2031/744

(57) ABSTRACT

A film has a skin layer, a base layer, and an intermediate layer between the skin and base layers. The skin layer has styrenic block copolymer, the base layer has ethylene/alpha-olefin copolymer, and the intermediate layer has from 12% to 50% styrene/ethylene-butadiene/styrene block copolymer. The film has a free shrink at 90° C. of at least 65% and a density of at most 0.960 grams per cubic centimeter.

This application claims under 35 U.S.C. §119(e) the benefit of U.S. Provisional Patent Application No. 61/825,643 filed May 21, 2013, which is incorporated herein in its entirety by reference.

The present invention relates to a shrink film useful, for example, for manufacture of a shrink sleeve.

### BACKGROUND

PET bottles may be recycled using the float recycling method. A shrink film incorporated in a shrink sleeve for such PET bottles must have a low density for use in this recycle method. Also, the shrink film would advantageously have a high level of shrink initiated at a relatively low temperature to be desirable for the shrink sleeve application. Achieving a high level of shrink at relatively low temperature may require the use of high stretching ratios at relatively low temperatures during manufacture of the shrink film. However, these processing conditions place severe forces on the adhesive bond holding together the layers of a multilayered film. These forces can delaminate the film's layers during the orientation process.

Further, certain solvents used during the seaming of a shrink film to make a shrink sleeve (i.e., solvent sealing) may transport through the film to adversely affect the interlayer bond strength of the multilayered shrink film, resulting in delamination during the subsequent shrinking step, for example, in a steam shrink tunnel or a hot air shrink tunnel.

### SUMMARY

One or more embodiments of the presently disclosed subject matter may address one or more of the aforementioned problems.

A film has at least the following layers: a skin layer, a base layer, and an intermediate layer between the skin and base layers and directly adjacent at least one of the skin layer and the base layer. The skin layer has at least 50% by weight of the skin layer of styrenic block copolymer having a styrene monomer content of at least 50 wt. %. The base layer has at least 50% by weight of the base layer of ethylene/alpha-olefin copolymer. The intermediate layer has at least 12% and at most 50%, by weight of the intermediate layer, of styrene/ethylene-butadiene/styrene block copolymer. The film has a free shrink at 90° C. in at least one of the transverse and machine directions of at least 65%. The film has a density of at most 0.960 grams per cubic centimeter.

The film may be made into a shrink sleeve for successful use in labeling PET bottles and in a float method of recycling such PET bottles. The film has a high level of shrink initiated at a relatively low temperature, yet can avoid interlayer delamination, for example at the seam of the sleeve label, when shrunk about the bottle.

The presently disclosed subject matter will be more readily understood and appreciated by reference to the detailed description of the invention and the drawings.

### BRIEF DESCRIPTION OF THE DRAWINGS

FIG. 1 is a representative perspective view of a shrink sleeve comprising an embodiment of the film of the present invention surrounding a container; and

FIG. 2 is a representative perspective view of the shrink sleeve of FIG. 1 shrunk about the container to provide a shrink labeled container.

### DETAILED DESCRIPTION

One or more embodiments of the presently disclosed subject matter disclose a film useful in shrink sleeve applications, the film having at least the following layers: a skin layer, a base layer, and an intermediate layer. These layers are discussed below.

The film may have a total thickness of at least, and/or at most, any of the following: 1, 1.6, 1.8, 2, 2.2, 3, 4, 5, 7, 9, 10, and 15 mils.

The film may comprise at least, and/or at most, any of the following numbers of layers: 3, 4, 5, 6, 7, 8, 9, 10, 11, 13, and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application.

The film may have a density (at 23° C.) of at most, and/or at least, any of the following: 0.960, 0.955, 0.950, 0.945, 0.940, and 0.930 grams/cubic centimeter. The density of the film is measured according to ASTM D792.

Below are some examples of combinations in which the alphabetical symbols designate the film layers. Where the multilayer film representation below includes the same letter more than once, each occurrence of the letter may represent the same composition or a different composition within the class that performs a similar function.

### A/B/C, A/B/C/A, A/B/C/B/A, A/B/D/C, A/D/B/C, A/B/C/D, A/B/D/B/C, A/D/C/B/A, A/B/C/D/A, A/B/D/C, A/B/D/C/B/A, A/B/D/C/D/B/A, A/B/C/C/A, A/B/C/C/B/A, A/B/C/D/C/B/A

“A” represents a skin layer, as discussed herein.
“B” represents an intermediate layer (e.g., a tie layer), as discussed herein.
“C” represents a base layer, as discussed herein.
“D” represents one or more other layers of the film, such as a bulk layer.

The film may include recycled film material in any of the layers (e.g., in the base layer). For example, the film may include recycled film material in at least, and/or at most, any of the following amounts: 5, 10, 15, 20, 25, and 30% by weight of the layer comprising the recycled film material.

### Skin Layer

The film comprises at least one skin layer forming an outer surface of the film. A skin layer is an “outer layer” of the film, that is, a layer that has only one side directly adhered to another layer of the film. For multilayered films, there inherently exists two outer layers of the film. An “outside layer” is an outer layer of the film that is, or is intended to be, facing outwardly from a label or package comprising the film. An “inside layer” of a film is an outer layer of the film that is, or is intended to be, facing inwardly from a label comprising the film (i.e., toward the labeled item) or from a package comprising the film (i.e., toward the package interior space).

In addition to a first skin layer, the film may comprise a second skin layer as an outer layer of the film. The composition, thickness, and other characteristics of the first and second skin layers may be any of those described below with respect to the skin layer. Any of the composition, thickness, and other characteristics of the second skin layer may be substantially the same as any of those of the first skin layer, or may differ from any of those of the first skin layer.

The first and/or second skin layers may each have a thickness of at least, and/or at most, any of the following: 0.05, 0.1, 0.15, 0.2, 0.25, 0.5, 1, 2, 3, 4, and 5 mils. The thickness of a skin layer as a percentage of the total thickness of the film may be at least, and/or at most, any of the following: 1, 3, 5, 7, 10, 15, 20, 25, 30, 35, 40, 45, and 50 percent. The weight of a skin layer as a percentage of the total weight of the film may be at least, and/or at most, any of the following: 3, 5, 7, 10, 15, 20, 25, and 30 percent.

A skin layer may comprise one or more of any of these below-described styrenic block copolymers, or one or more of any class of styrenic block polymers (e.g., SBS), in at least, and/or at most, any of the following amounts: 50, 60, 70, 75, 80, 90, 95, and 100%, by weight of the layer.

The first and/or second skin layers each comprise: (i) styrenic block copolymer (“SBC”) and optionally (ii) polystyrene having a styrene monomer content of at least 90 wt. %.

### Styrenic Block Copolymer

The first and/or second skin layers comprise styrenic block copolymer (“SBC”). “Copolymer” as used in this application means a polymer derived from two or more types of monomers, and includes terpolymers, etc. Styrenic block copolymer includes: (i) styrene/conjugated diene/styrene block copolymers, for example styrene/butadiene/styrene copolymer (“SBS”) and styrene/isoprene/styrene copolymer (“SIS”), (ii) styrene/ethylene-butylene/styrene copolymer (“SEBS”), (iii) styrene/ethylene-propylene/styrene (“SEPS”), (iv) styrene/ethylene-propylene copolymer (“SEP”), and (v) these polymers modified with unsaturated carboxylic acid anhydride.

The first and/or second skin layers may comprise SBC having a styrene monomer content of at least, and/or at most, any of the following: 50, 55, 60, 65, 70, 75, 80, 85, and 90 wt. %.

The SBC, for example SBS, may have a butadiene comonomer content of at most any of the following: 30, 40, 50, 60, 65, 68, 70, 72, 75, 80, 85, 88, and 90 wt %; and at least any of the following: 27, 30, 35, 50, 60, 65, 68, 70, 72, 75, 80, and 85 wt. %, based on the weight of the SBC. The butadiene comonomer content may range between two or more ranges of the forgoing values, for example, from 65 to 75 wt. % and from 30 to 65 wt. %.

The SBC, for example SIS, may have a isoprene comonomer content of at most any of the following: 30, 40, 50, 60, 65, 68, 70, 72, 75, 80, 85, 88, and 90 wt. %; and at least any of the following: 27, 30, 35, 50, 60, 65, 68, 70, 72, 75, 80, and 85 wt. %, based on the weight of the SBC. The isoprene comonomer content may range between two or more ranges of the forgoing values, for example, from 65 to 75 wt. % and from 30 to 65 wt. %.

SBC (e.g., SBS, SIS) may comprise a substantially unsaturated elastomeric midblock such as a conjugated diene midblock (e.g., butadiene or isoprene comonomer midblock).

SBC (e.g., SEBS, SEPS) may comprise a substantially saturated midblock.

SBC (e.g., SEBS, SEPS) may be modified (i.e., maleic anhydride grafted) as discussed in the “modified ethylene/unsaturated ester copolymer” section of this Application.

The first and/or second skin layers may comprise SBC (e.g., any one or more of any of the types of SBC discussed herein) in an amount of at least any of the following: 50, 55, 60, 70, 75, 80, 85, 90, 95, 98, and 100 wt. %; and at most any of the following: 100, 90, 80, 70, 60, 50 wt. %, based on the weight of the skin layer. The skin layer may consist of, or consist essentially of, SBC.

### Polystyrene

The first and/or second skin layers layer may comprise polystyrene having a styrene monomer content of at least 90 wt. %, for example, at least any of the following: 93, 95, 97, and 99 wt. % styrene monomer content based on the weight of the polymer. The polystyrene may be any one of substantially atactic, syndiotactic, and/or isotactic. It is believed that the inclusion of such polystyrene may enhance the Young's modulus of the film. Processing aids—such as mineral oil, paraffin oil, naphthenic oil, waxes (e.g., erucacmide, oleamide, and bis-stearamide), silicone, and soybean oil—may be mixed with the polystyrene in an amount, for example, of from 1 to 5 wt parts processing aid to 100 weight parts polystyrene.

The first and/or second skin layers may comprise polystyrene having a styrene monomer content of at least 90 wt. % (such as any of those described in this section) in at most, and/or at least, any of the following amounts: 0.5, 1, 3, 5, 8, 10, 13, 15, 18, 20, 23, 25, and 30%, based on the weight of the skin layer.

### Base Layer

The base layer may be an outer layer of the film; or the base layer may be an inner layer of the film. An “inner” layer is a layer that has both sides directly adhered to other layers of the film.

The base layer may have a thickness of at least, and/or at most, any of the following: 0.25, 0.5, 1, 2, 3, 4, 5, 8, 10, and 15 mils. The thickness of the base layer as a percentage of the total thickness of the film may be at least, and/or at most, any of the following: 20, 25, 30, 35, 40, 45, 50, 60, 70, and 80 percent. The weight of the base layer as a percentage of the total weight of the film may be at least, and/or at most, any of the following: 20, 30, 40, 50, 60, 70, 80, and 90 percent.

The base layer comprises ethylene/alpha-olefin copolymer, for example, one or more of, any of the below-described ethylene/alpha-olefin copolymers, or one or more of any class of ethylene/alpha-olefin copolymers (e.g., LLDPE or EAOs having recited densities ranges) described below, in at least, and/or at most, any of the following amounts: 50, 60, 70, 75, 80, 90, 95, 98, and 100%, by weight of the layer.

EAOs are copolymers of ethylene and one or more alpha-olefins, the copolymer having ethylene content as the majority mole-percentage content. The comonomer alpha-olefin may be selected from one or more of any of the C₃-C₂₀ α-olefins, such as the C₄-C₁₂ α-olefins, the C₄-C₈ α-olefins, 1-butene, 1-hexene, and 1-octene. Useful EAOs include one or more of the following: 1) medium density polyethylene (“MDPE”), for example having a density of from 0.926 to 0.940 g/cm3; 2) linear medium density polyethylene (“LMDPE”), for example having a density of from 0.926 to 0.940 g/cm3; 3) linear low density polyethylene (“LLDPE”), for example having a density of from 0.915 to 0.930 g/cm3; 4) very-low or ultra-low density polyethylene (“VLDPE” and “ULDPE”), for example having density below 0.915 g/cm3, and 5) homogeneous EAOs.

Useful EAOs also include those having a density of less than any of the following: 0.925, 0.922, 0.920, 0.917, 0.915, 0.912, 0.910, 0.907, 0.905, 0.903, 0.900, 0.898, and 0.897 grams/cubic centimeter, Unless otherwise indicated, all densities herein are measured according to ASTM D1505.

The EAOs may be either heterogeneous or homogeneous. As is known in the art, heterogeneous polymers have a relatively wide variation in molecular weight and composition distribution. Heterogeneous polymers may be prepared with, for example, conventional Ziegler-Natta catalysts.

On the other hand, homogeneous polymers are typically prepared using metallocene or other single-site catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the ExxonMobil Corporation (Baytown, Tex.) under the EXACT trademark (e.g., EXACT 3024 ethylene/butene copolymer) and EXCEED trademark (e.g., EXCEED 4518 PA ethylene/hexene copolymer), linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

The base layer may optionally further comprise one or more other polymers than EAOs, such as ethylene/cyclic olefin copolymer (e.g., ethylene/norbornene copolymer).

### Intermediate Layer

The film comprises one or more intermediate layers. In addition to a first intermediate layer, the film may comprise a second intermediate layer. The composition, thickness, and other characteristics of the first and second intermediate layers may be any of those described below with respect to the intermediate layer. Any of the composition, thickness, and other characteristics of the second intermediate layer may be substantially the same as any of those of the first intermediate layer, or may differ from any of those of the first intermediate layer.

An intermediate layer may be, for example, between the skin layer and the base layer. An intermediate layer may be directly adjacent the skin layer, so that there is no intervening layer between the intermediate and skin layers. An intermediate layer may be directly adjacent the base layer, so that there is no intervening layer between the intermediate and base layers. An intermediate layer may be directly adjacent both the skin layer and the base layer.

The first and/or second intermediate layers may each have a thickness of at least, and/or at most, any of the following: 0.05, 0.1, 0.15, 0.2, 0.25, 0.5, 1, 2, 3, 4, and 5 mils. The thickness of an intermediate layer as a percentage of the total thickness of the film may be at least, and/or at most, any of the following: 1, 3, 5, 7, 10, 15, 20, 25, 30, 35, 40, 45, and 50 percent. The weight of an intermediate layer as a percentage of the total weight of the film may be at least, and/or at most, any of the following: 3, 5, 7, 10, 15, 20, 25, and 30 percent.

### Styrene/Ethylene-Butadiene/Styrene Block Copolymer

The first and/or second intermediate layers comprise styrene/ethylene-butadiene/styrene block copolymer (“SEBS”). Generally, SEBS as used in this application includes SEBS in an unmodified form, or these polymers modified with unsaturated carboxylic acid anhydride.

The SEBS may have a styrene monomer content of at least, and/or at most, any of the following: 12, 13, 15, 16, 18, 20, 22, and 25 mole %. The SEBS may have styrene block to rubber block ratio (mole to mole ratio) of at least, and/or at most, any of the following: 10:90; 15:85; 20:80; 25:75; and 30:70.

The first and/or second intermediate layers comprise one or more of any of the styrene/ethylene-butadiene/styrene copolymers described herein in at least any of the following amounts: 12, 14, 15, 18, 20, 22, 25, 30, 35, 40, and 45 by weight of the intermediate layer; and/or at most any of the following amounts: 14, 15, 18, 20, 22, 25, 30, 35, 40, 45, and 50%, by weight of the intermediate layer.

SEBS may be modified (e.g., maleic anhydride grafted) as discussed in the “modified ethylene/unsaturated ester copolymer” section of this Application.

### Ethylene/Unsaturated Ester Copolymer

The first and/or second intermediate layers may further comprise one or more ethylene/unsaturated ester copolymers. Ethylene/unsaturated ester copolymer includes copolymers of ethylene and one or more unsaturated ester monomers.

The first and/or second intermediate layers comprise ethylene/unsaturated ester copolymer (e.g., any of one or more of any of the ethylene/unsaturated ester copolymers discussed herein) in at least, and/or at most, any of the following amounts: 50, 55, 60, 65, 70, 75, 78, 80, 85, 86, and 88%, by weight of the layer. The intermediate layer may comprise unmodified ethylene/unsaturated ester copolymer (i.e., ethylene/unsaturated ester copolymer that is not modified as discussed herein) in any of the amounts set forth in the previous sentence.

Useful unsaturated esters include:
1) vinyl esters of aliphatic carboxylic acids, where the esters have from 4 to 12 carbon atoms,
2) alkyl esters of acrylic or methacrylic acid (collectively, “alkyl (meth)acrylate”), where the esters have from 4 to 12 carbon atoms, and
3) glycidyl esters of acrylic or methacrylic acid (collectively, “glycidyl (meth)acrylate”). The ethylene/unsaturated ester copolymer may comprise a mixture of the second and third types of comonomers, for example to form an ethylene/alkyl (meth)acrylate/glycidyl (meth)acrylate copolymer.

Representative examples of the first (“vinyl ester”) group of monomers include vinyl acetate, vinyl propionate, vinyl hexanoate, and vinyl 2-ethylhexanoate. The vinyl ester monomer may have at least any of the following number of carbon atoms: 4, 5, and 6 carbon atoms; and may have at most any of the following number of carbon atoms: 4, 5, 6, 8, 10, and 12 carbon atoms.

Representative examples of the second (“alkyl (meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl (meth)acrylate monomer may have at least any of the following number of carbon atoms: 4, 5, and 6 carbon atoms; and may have at most any of the following number of carbon atoms: 4, 5, 6, 8, 10, and 12 carbon atoms.

Representative examples of the third (“glycidyl (meth)acrylate”) group of monomers include glycidyl acrylate and glycidyl methacrylate (“GMA”).

The ethylene/unsaturated ester copolymer may comprise (i) vinyl ester of aliphatic carboxylic acid comonomer content of any one or more of the above listed types of vinyl esters of aliphatic carboxylic acids and/or (ii) alkyl (meth)acrylate comonomer content of any one or more of the above listed types of alkyl (meth)acrylates in at least any of the following amounts (based on the weight of the copolymer): 3, 5, 10, 15, 20, 22, 23, 24, 25, 26, 27, 28, 29, 30, 32, 34, 36, 38, 40, 45, 50, 55, and 60 wt. %; and at most any of the following amounts (based on the weight of the copolymer): 10, 15, 20, 25, 26, 27, 28, 29, 30, 32, 34, 36, 38, 40, 45, 50, 55, 60, 65, 70, 75, and 80 wt. %.

The ethylene/unsaturated ester copolymer may comprise glycidyl (meth)acrylate comonomer content (e.g., any one or more of the above listed types of glycidyl (meth)acrylates) in at least any of the following amounts (based on the weight of the copolymer): 0.5, 1, 2, 3, 4, 5, 6, 7, 8, 9, and 10 wt. %; and at most any of the following amounts (based on the weight of the copolymer): 1, 2, 3, 4, 5, 6, 7, 8, 9, 10, and 12 wt %.

The unsaturated ester comonomer content (e.g., the vinyl ester, alkyl (meth)acrylate, and/or glycidyl (meth)acrylate comonomer content) of the ethylene/unsaturated ester copolymer may collectively total at least any of the following amounts (based on the weight of the copolymer): 20, 22, 23, 25, 26, 27, 28, 29, 30, 32, 34, 36, 38, 40, 45, 50, 55, and 60 wt. %; and may collectively total at most any of the following amounts (based on the weight of the copolymer): 30, 32, 34, 36, 38, 40, 45, 50, 55, 60, 65, 70, 75, and 80 wt. %.

The ethylene monomer content of the ethylene/unsaturated ester copolymer may be at least, and/or at most, any of the following (based on the weight of the copolymer): 45, 50, 55, 60, 65, 70, and 80 wt. %.

Representative examples of ethylene/unsaturated ester copolymers include:

ethylene/vinyl acetate,

ethylene/C₁-C₁₂ alkyl (meth)acrylate copolymers;

ethylene/methyl acrylate,

ethylene/methyl methacrylate,

ethylene/ethyl acrylate,

ethylene/ethyl methacrylate,

ethylene/butyl acrylate,

ethylene/2-ethylhexyl methacrylate,

ethylene/glycidyl acrylate,

ethylene/glycidyl methacrylate,

ethylene/methyl acrylate/glycidyl acrylate,

ethylene/methyl methacrylate/glycidyl acrylate,

ethylene/ethyl acrylate/glycidyl acrylate,

ethylene/ethyl methacrylate/glycidyl acrylate,

ethylene/butyl acrylate/glycidyl acrylate,

ethylene/2-ethylhexyl methacrylate/glycidyl acrylate,

ethylene/methyl acrylate/glycidyl methacrylate,

ethylene/methyl methacrylate/glycidyl methacrylate,

ethylene/ethyl acrylate/glycidyl methacrylate,

ethylene/ethyl methacrylate/glycidyl methacrylate,

ethylene/butyl acrylate/glycidyl methacrylate, and

ethylene/2-ethylhexyl methacrylate/glycidyl methacrylate.

Generally, ethylene/unsaturated ester copolymer as used herein includes modified ethylene/unsaturated ester copolymer. The intermediate layer may comprise ethylene/unsaturated ester copolymer, modified ethylene/unsaturated ester copolymer, or mixtures thereof, in any of the amounts set forth herein. Modified ethylene/unsaturated ester copolymer includes ethylene/unsaturated ester copolymers (i.e., any of the ethylene/unsaturated ester copolymers described herein), which are modified (e.g., grafted) with unsaturated carboxylic acid anhydride (i.e., anhydride-modified polymer) to incorporate anhydride functionality. The modification may promote or enhance the adhesion characteristics of the copolymer. Examples of unsaturated carboxylic acid anhydrides include maleic anhydride, fumaric anhydride, and unsaturated fused ring carboxylic add anhydrides (e.g., as described in U.S. Pat. No. 4,087,588).

Examples of modified ethylene/unsaturated ester copolymer include: maleic anhydride-grafted ethylene/vinyl acetate copolymer having a vinyl acetate comonomer content of about 25 wt. % available from DuPont Corporation under the BYNEL 3861 trademark; maleic anhydride modified ethylene/vinyl acetate copolymer having a vinyl acetate monomer content of about 28 wt. % available from DuPont Corporation under the FUSABOND MC250D trade name; and ethylene/alkyl acrylate/maleic anhydride copolymers, such as ethylene/ethyl acrylate/maleic anhydride copolymer containing 27.5 wt. % acrylate comonomer content and 2.9 wt/% maleic anhydride (“MAH”) comonomer content; ethylene/ethyl acrylate/maleic anhydride copolymer containing 20% acrylate comonomer content and 3% MAH comonomer content; the LOTADER series of ethylene/alkyl acrylate/maleic anhydride interpolymers (Elf-Atochem, Inc.; Buffalo, N.Y.); maleic anhydride-grafted ethylene/methyl acrylate copolymer available from Dupont Corporation under the BYNEL 21E810 trade name; and ethylene/vinyl acetate/maleic anhydride terpolymer available under the OREVAC 9314 trade name (14% vinyl acetate and 1% maleic anhydride).

Useful anhydride-modified polymers may contain anhydride moiety in an amount (based on the weight of the modified polymer) of at least, and/or at most, any of the following: 0.1%, 0.5%, 1%, 2%, 4%, 5%, 8%, and 10%. The anhydride-modified polymer may be made by grafting or copolymerization.

The intermediate layer may comprise modified ethylene/unsaturated ester copolymer in an amount of at least, and/or at most, any of the following: 50, 55, 60, 65, 70, 75, 78, 80, 85, 86, and 88%, by weight of the layer. The intermediate layer may comprise modified ethylene/unsaturated ester copolymer and unmodified ethylene/unsaturated ester copolymer totaling any of the amounts set forth in the previous sentence.

### Addititives

One or more layers of the film may include one or more additives useful in thermoplastic films, such as, antiblocking agents, slip agents, colorants, pigments, dyes, antimicrobial agents, antioxidants, fillers, radiation stabilizers, and antistatic agents.

### Modulus of the Film

The film preferably exhibits a Young's modulus sufficient to withstand the expected handling and use conditions. Young's modulus may be measured in accordance with one or more of the following ASTM procedures: D882; D5026-95a; D4065-89, each of which is incorporated herein in its entirety by reference.

The film may have a Young's modulus of at least, and/or at most, any of the following: 60,000; 100,000; 130,000; 150,000; 200,000; 250,000; 300,000; 350,000; and 400,000 pounds/square inch, measured at a temperature of 73° F. The film may have any of the forgoing ranges of Young's modulus in at least one direction (e.g., in the machine direction or in the transverse direction) or in both directions (i.e., the machine (i.e., longitudinal) and the transverse directions).

### Interlayer Bond Strength

The term “interlayer bond strength” of the film as used herein means the average amount of force required to separate or delaminate two adjacent film layers either by adhesive failure between the layers or by cohesive failure through one of the two adjacent film layers (whichever occurs first), as measured in accordance with ASTM F88 where the testing machine (e.g., Instron tensile tester) crosshead speed is 5 inches per minute, using five, 1-inch wide, representative samples and a test temperature of room temperature (i.e., about 68° F.), unless otherwise specified below. ASTM F88 is incorporated herein in its entirety by reference. To prepare a film sample for a test of the interlayer bond strength, a portion of the film may be separated at an interface between layers to provide specimen legs for insertion into the grips of the testing machine. For example, pressure-sensitive adhesive tape may be adhered to opposite outer sides of the film to leave a gripping tab of tape extending from each side of the film. The tabs may then be grasped and yanked in opposite directions to partially separate film layers.

As used herein, an “adhesive failure” is a failure in which the interfacial forces (e.g., valence forces or interlocking action or both) holding two surfaces together are overcome. A “cohesive failure” is one in which the molecular attractive forces holding together a layer composition are overcome. The interlayer bond strength of the film may be at least, and/or at most, any of the following values: 1,000; 1,500; 2,000; 2,500; 3,000; and 3,500 grams (force)/inch.

### Appearance Characteristics of the Film

The film may have low haze characteristics. Haze is a measurement of the transmitted light scattered more than 2.5° from the axis of the incident light. Unless otherwise noted, haze is measured against the outside layer of the film. Haze is measured according to the method of ASTM D 1003, which is incorporated herein in its entirety by reference. All references to a “haze” value for a film in this application are by this standard. The haze of the film may be at most, and/or at least, any of the following values: 20%, 15%, 10%, 8%, 5%, 3, 2%, and 1%.

The film may have a gloss (i.e., specular gloss) as measured against the outside layer of at least, and/or at most, any of the following values: 70%, 75%, 80%, 85%, 90%, and 95%. These percentages represent the ratio of light reflected from the sample to the original amount of light striking the sample at the designated angle. All references to “gloss” values in this application are in accordance with ASTM D 2457 (45° angle), which is incorporated herein in its entirety by reference.

The film may be transparent (at least in the non-printed regions) so that a packaged article may be visible through the film. “Transparent” means that the film transmits incident light with negligible scattering and little absorption, enabling objects (e.g., the packaged article or print) to be seen clearly through the film under typical viewing conditions (i.e., the expected use conditions of the material). The regular transmittance (i.e., clarity) of the film may be at least, and/or at most, any of the following values: 50%, 60%, 65%, 70%, 75%, 80%, 85%, and 90%, measured in accordance with ASTM D1746. All references to “regular transmittance” values in this application are by this standard.

The total luminous transmittance (i.e., total transmittance) of the film may be at least, and/or at most, any of the following values: 40%, 50%, 60%, 65%, 70%, 75%, 80%, 85%, and 90%, measured in accordance with ASTM D1003. All references to “total luminous transmittance” values in this application are by this standard.

The measurement of optical properties of plastic films, including the measurement of total transmission, haze, clarity, and gloss, is discussed in detail in Pike, LeRoy, “Optical Properties of Packaging Materials,” Journal of Plastic Film & Sheeting, vol. 9, no. 3, pp. 173-80 (July 1993), of which pages 173-80 is incorporated herein by reference.

### Manufacture of the Film

The manufacture of the film uses thermoplastic film-forming processes known in the art. The film may be prepared by extrusion or coextrusion utilizing, for example, a tubular trapped bubble film process, a flat or tube cast film process, or a slit die flat cast film process. The film may also be prepared by applying one or more layers by extrusion coating, adhesive lamination, extrusion lamination, solvent-borne coating, or by latex coating (e.g., spread out and dried on a substrate). A combination of these processes may also be employed.

The film may be oriented in either the machine (i.e., longitudinal), the transverse direction, or in both directions (i.e., biaxially oriented), for example, to enhance the strength, optics, and durability of the film. A web or tube of the film may be uniaxially or biaxially oriented by imposing a draw force at a temperature where the film is softened (e.g., above the vicat softening point; see ASTM 1525) and for example at a temperature below the film's melting point. The film may be oriented using, for example, a tenter-frame process or a bubble process.

The orientation may occur in any of one direction (i.e., the machine or transverse directions) and/or two directions (e.g., the machine and transverse directions) by at least, and/or at most, any of the following ratios: 3:1, 3.5:1, 4:1, 5:1, 6:1, 7:1, 8:1, 9:1, 10:1, 12:1, and 15:1. The film may be stretched by any of these amounts in one direction and another of any of these amounts in the other direction. The film may be stretched by any of these amounts in one direction and not stretched in the other direction.

The orientation temperature (i.e., the temperature of the film during the stretch orientation step) may be, for example, at most any one of the following: 85, 83, and 80° C.; and/or at least any one of the following: 75, 78, 80, and 82° C.

The film may be annealed or heat-set at a given anneal temperature for a relatively short time to slightly or substantially reduce the amount of free shrink at the anneal temperature, and for example to raise the shrink initiation temperature. The anneal temperature may be at least, and/or at most, any of the following: 65° C., 70° C., 75° C., and 80° C.

The film is then cooled to retain the physical properties generated during orientation and to provide the heat-shrink characteristic to the film.

The film has a free shrink at 90° C. in any of at least one direction (i.e., the machine direction or the transverse direction), in only one direction (i.e., the machine direction or the transverse direction), and/or in both the machine and transverse directions of at least, and/or at most, any of the following: 65%, 68%, 70%, 75%, and 80%. The film may have any of the forgoing shrink amounts in only one of the machine and/or transverse directions.

The film may have a free shrink at 90° C. in one of either the transverse direction or the machine direction of at most any of 3%, 2%, 1%, 0%, −1%, −2%, −3%, and −4% free shrink. (A negative free shrink indicates that the film expanded in that direction.)

The free shrink of the film is determined by measuring the percent dimensional change in a 10 cm×10 cm film specimen when subjected to selected heat (i.e., at the specified temperature exposure) according to ASTM ID 2732, which is incorporated herein in its entirety by reference. All references to free shrink in this application are measured according to this standard.

The film may have a printed image applied to it, for example, by any suitable ink printing method, such as rotary screen, gravure, or flexographic techniques. The printed image may be applied to a skin layer. The printed image may be applied as a reverse printed image, for example, applied to the inside layer of the film of a shrink sleeve.

### Shrink Sleeve

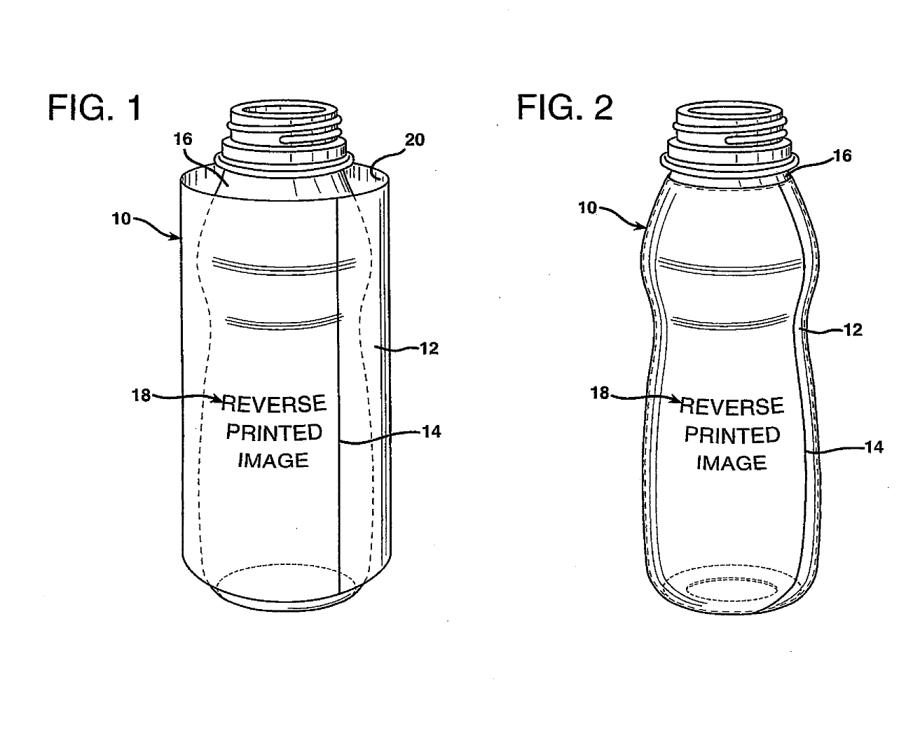

A shrink sleeve 10 (also known as a shrink sleeve label or a shrink band) may comprise any one of any of the embodiments of the inventive film 12 described herein. (See, e.g., FIGS. 1-2.) The shrink sleeve 10 may be a seamed shrink sleeve (illustrated in FIG. 1), a seamless shrink sleeve, or a roll-fed shrink sleeve (i.e., formed by roll-fed shrink film for wraparound labeling). The film may be seamed into a shrink sleeve by use of a solvent seam process known in the art. Useful solvents include tetrahydrofuran (THF), xylene, toluene, and cyclohexanone.

A seamed shrink sleeve that comprises the film may be manufactured from a flat configuration of the film, which is seamed into a tube by attaching the film to itself to form a tube having a seam 14 using, for example, an adhesive seam or solvent seam as described above. If the sleeve 10 is to be printed, then the formation of the film into a tube may occur after images have been printed onto the film. The printed image 18 may be applied as a reverse printed image to the inside surface 20. The tube may then be wound onto a core. The roll of tubing may then be unwound from the core and cut to individual lengths to form the individual seamed shrink sleeves. The shrink sleeve may then be placed to surround the item (e.g., container 16) to which the shrink sleeve is to be applied. Heat may then be applied (e.g., by placing the shrink-sleeved item into a heat tunnel using, for example, steam or hot air) so that the heat shrink characteristic of the shrink sleeve is activated and the shrink sleeve shrinks to conform to the shape of the item that the shrink sleeve surrounds, as illustrated in FIG. 2.

A seamless shrink sleeve that comprises the film may be manufactured by extruding the film in a tube configuration having a desired tube configuration. The resulting tube may be printed and cut to desired lengths to form individual shrink sleeves.

A roll-fed shrink sleeve comprising the film may be manufactured by: 1) applying a pick-up adhesive to the leading edge of the film that has been cut into the desired dimensions, 2) adhering the leading edge to a container, 3) moving the container and the film relative each other so that the film surrounds the container, 4) applying an adhesive to the trailing edge of the film, 5) adhering the trailing edge of the film to the container or to the leading edge area of the film, and 6) exposing the shrink sleeve/container to heat to activate the shrink characteristic of the film.

A shrink sleeve comprising the film may be used, for example: 1) as a label applied to an item, 2) as a tamper-evident seal or packaging material (e.g., a tamper-evident neck band), and/or 3) to unitize two or more items (e.g., multi-packing). The shrink sleeve may be a full-body sleeve for enclosing a container. The shrink sleeve may be used to enclose a shaped and/or contoured container (e.g., an asymmetrically-shaped container).

The following examples are presented for the purpose of further illustrating and explaining one or more embodiments of the present invention and are not to be taken as limiting in any regard. Unless otherwise indicated, all parts and percentages are by weight.

In the examples below, these abbreviations have the following meanings:
COC1 is a homogeneous ethylene/norbornene copolymer available from Topas Advanced Polymers, Inc. under the Topas 9903D-10 trade name, having a nominal density of 0.974 glcc and a nominal glass transition temperature of 33° C.
EAO1 is an ethylene/octene copolymer single-site catalyzed VLDPE available from Dow Corporation under the Affinity PF 1140G trade name, having a nominal density of 0.8965 g/cc and a nominal comonomer content of 14%.
EMA1 is an ethylene/methyl acrylate copolymer available from Westlake Chemical under the SP2260 trade name, having a nominal methyl acrylate comonomer content of 24% and a nominal density of 0.944.
PS1 is a polystyrene homopolymer available from Ineos Nova LLC under the PS 3100 trade name, having a nominal density of 1.02 g/cc.
SBS1 is a styrene/butadiene block copolymer available from BASF Corporation under the Styrolux HS 70 trade name, having a nominal density of 1.02 g/cc.
SBS2 is a styrene/butadiene block copolymer available from Chevron Phillips Corporation under the K-Resin KR52 trade name, having a nominal density of 1.01 g/cc.
SBS3 is a styrene/butadiene block copolymer available from BASF Corporation under the Styroflex 2G 66 trade name, having a nominal density of 0.99 g/cc and a styrene comonomer content of at least 65%.
SEBS1 is a styrene/ethylene-butylene/styrene block copolymer available from Kraton Polymers LLC under the KRATON G1643 MS trade name, having a reported styrene comonomer content of from 16.6 to 20.6 mole %, a nominal density of 0.9 g/cc, a melt flow index of from 12.5 to 25.0 g/10 min (nominally 18) (230° C./2160 g ASTM D1238), index of refraction of 1.500, an E-B rubber block glass transition temperature of about −35° C., and a nominal styrene block to rubber block ratio of 20 to 80.
MB1 is a masterbatch of antiblock and slip agents comprising polystyrene homopolymer carrier, N,N′-ethylene-bis-stearamide slip agent, and alkali-alumino-silicate ceramic sphere antiblock agent.

### Samples 1 to 23

Five-layer films (Samples 1 to 23) were made by extruding an extrudate film having an A/B/C/B/A film layer configuration where the “A” skin layers, the “B” intermediate layers, and the “C” base layer had the compositions shown in Tables 1, 2, and 3.

The extrudate film was extruded using four extruders and a feedblock configured above a die to form the relatively thick extrudate film having the thickness shown in the tables. The extrudate film was then preheated, and oriented using a tenterframe machine only in the transverse direction at a orientation ratio of 6.2:1. The resulting oriented film was annealed for a relatively short time and then allowed to cool to ambient temperature. The temperatures of the preheat, orientation, and anneal are shown in the tables. The thickness of the oriented film is also shown in the tables, as well as the other properties of the oriented film.

TABLE 1

| Sample | | | | | | | |
|---|---|---|---|---|---|---|---|
| 1 | 2 | 3 | 4 | 5 | 6 | 7 | 8 |

Layer Composition (component—wt. %):

| | | | | | | | | |
|---|---|---|---|---|---|---|---|---|
| A | SBS1- | SBS1- | SBS1- | SBS1- | SBS1- | SBS1- | SBS1- | SBS1- |
| | 96.5% | 96.5% | 81.5% | 81.5% | 96.5% | 96.5% | 96.5% | 96.5% |
| | MB1- | MB1- | PS1- | PS1- | MB1- | MB1- | MB1- | MB1- |
| | 3.5% | 3.5% | 15.0% | 15.0% | 3.5% | 3.5% | 3.5% | 3.5% |
| | | | MB1- | MB1- | | | | |
| | | | 3.5% | 3.5% | | | | |
| B | EMA1- | EMA1- | EMA1- | EMA1- | EMA1- | EMA1- | EMA1- | EMA1- |
| | 85% | 85% | 85% | 85% | 85% | 85% | 85% | 85% |
| | SEBS1- | SEBS1- | SEBS1- | SEBS1- | SEBS1- | SEBS1- | SEBS1- | SEBS1- |
| | 15% | 15% | 15% | 15% | 15% | 15% | 15% | 15% |
| C | EAO1- | EAO1- | EAO1- | EAO1- | EAO1- | EAO1- | EAO1- | EAO1- |
| | 100% | 100% | 100% | 100% | 100% | 100% | 80% | 80% |
| | | | | | | | COC1- | COC1- |
| | | | | | | | 20% | 20% |
| Density | 0.949 | | 0.956 | | 0.938 | | 0.945 | |
| (g/cc) | | | | | | | | |
| Extrudate | 8.4 | 8.4 | 12.2 | 12.2 | 12.2 | 12.2 | 12.2 | 12.2 |
| Film | | | | | | | | |
| Thickness | | | | | | | | |
| (mils) | | | | | | | | |
| Final Film | 34 | 34 | 50 | 50 | 50 | 50 | 50 | 50 |
| Thickness | | | | | | | | |
| (micron) | | | | | | | | |

Layer weight % relative total film:

| | | | | | | | | |
|---|---|---|---|---|---|---|---|---|
| A (each) | 14.5% | 14.5% | 14.5% | 14.5% | 10.5% | 10.5% | 10.9% | 10.9% |
| B (each) | 10.0% | 10.0% | 9.0% | 9.0% | 9.4% | 9.4% | 9.8% | 9.8% |
| C | 51.1% | 51.1% | 53.0% | 53.0% | 60.2% | 60.2% | 58.7% | 58.7% |

Transverse direction (TD) free shrink %

| | | | | | | | | |
|---|---|---|---|---|---|---|---|---|
| @80° C. | 48 | 54 | 52 | 51 | 50 | 52 | 50 | 53 |
| @90° C. | 69 | 71 | 72 | 69 | 70 | 72 | 71 | 71 |

Machine direction (MD) free shrink % (negative number indicates expansion)

| | | | | | | | | |
|---|---|---|---|---|---|---|---|---|
| @80° C. | −1 | −1 | −2 | −1 | −2 | −2 | 0 | 0 |
| @90° C. | −1 | −2 | −2 | −2 | −2 | −2 | −2 | −1 |
| TDO | 87.0 | 87.8 | 85.0 | 87.8 | 85.0 | 87.8 | 85.0 | 87.8 |
| preheat | | | | | | | | |
| (° C.) | | | | | | | | |
| TDO | 82.0 | 82.2 | 79.4 | 82.2 | 79.4 | 82.2 | 79.4 | 82.2 |
| stretch | | | | | | | | |
| (° C.) | | | | | | | | |
| TDO | 75.0 | 75.0 | 75.0 | 75.0 | 75.0 | 75.0 | 75.0 | 75.0 |
| anneal | | | | | | | | |
| (° C.) | | | | | | | | |
| Clarity | 72.2 | 72 | 70.5 | 69.8 | 71.4 | 72.4 | 68.3 | 64.5 |
| Gloss | 101 | 98 | 91 | 82 | 100 | 99 | 101 | 96 |
| Haze | 4 | 4.5 | 6.2 | 8.5 | 4 | 4.2 | 4.1 | 6 |

TABLE 2

| Sample | | | | | | | |
|---|---|---|---|---|---|---|---|
| 9 | 10 | 11 | 12 | 13 | 14 | 15 | 16 |

Layer Composition (component—wt. %):

| | | | | | | | | |
|---|---|---|---|---|---|---|---|---|
| A | SBS2- | SBS2- | SBS2- | SBS2- | SBS2- | SBS2- | SBS2- | SBS2- |
| | 96.5% | 96.5% | 81.5% | 81.5% | 81.5% | 81.5% | 81.5% | 81.5% |
| | MB1- | MB1- | PS1- | PS1- | PS1- | PS1- | PS1- | PS1- |
| | 3.5% | 3.5% | 15.0% | 15.0% | 15.0% | 15.0% | 15.0% | 15.0% |
| | | | MB1- | MB1- | MB1- | MB1- | MB1- | MB1- |
| | | | 3.5% | 3.5% | 3.5% | 3.5% | 3.5% | 3.5% |
| B | EMA1- | EMA1- | EMA1- | EMA1- | EMA1- | EMA1- | EMA1- | EMA1- |
| | 85% | 85% | 85% | 85% | 85% | 85% | 85% | 85% |
| | SEBS1- | SEBS1- | SEBS1- | SEBS1- | SEBS1- | SEBS1- | SEBS1- | SEBS1- |
| | 15% | 15% | 15% | 15% | 15% | 15% | 15% | 15% |
| C | EAO1- | EAO1- | EAO1- | EAO1- | EAO1- | EAO1- | EAO1- | EAO1- |
| | 100% | 100% | 100% | 100% | 100% | 80% | 80% | 80% |
| | | | | | | COC1- | COC1- | COC1- |
| | | | | | | 20% | 20% | 20% |
| Density | | | | | | | | 0.936 |
| (g/cc) | | | | | | | | |
| Extrudate | 12.2 | 12.2 | 12.2 | 12.2 | 12.2 | 12.2 | 12.2 | 12.2 |
| Film | | | | | | | | |
| Thickness | | | | | | | | |
| (mils) | | | | | | | | |
| Final Film | 50 | 50 | 50 | 50 | 50 | 50 | 50 | 50 |
| Thickness | | | | | | | | |
| (micron) | | | | | | | | |

Layer weight % relative total film:

| | | | | | | | | |
|---|---|---|---|---|---|---|---|---|
| A (each) | 15.7% | 15.7% | 15.7% | 15.1% | 15.1% | 14.9% | 11.2% | 11.2% |
| B (each) | 9.6% | 9.6% | 9.6% | 9.8% | 9.8% | 9.9% | 9.7% | 9.7% |
| C | 49.4% | 49.4% | 49.4% | 50.2% | 50.2% | 50.5% | 58.2% | 58.2% |

Transverse direction (TD) free shrink %

| | | | | | | | | |
|---|---|---|---|---|---|---|---|---|
| @80° C. | 61 | 62 | 57 | 59 | 44 | 57 | 57 | 51 |
| @90° C. | 75 | 76 | 74 | 74 | 67 | 73 | 72 | 71 |

Machine direction (MD) free shrink % (negative number indicates expansion)

| | | | | | | | | |
|---|---|---|---|---|---|---|---|---|
| @80° C. | 0 | 0 | 0 | 0 | −2 | −2 | 0 | 1 |
| @90° C. | −1 | 0 | −2 | −1 | −3 | −3 | −1 | 0 |
| TDO | 85.0 | 85.0 | 82.2 | 87.8 | 85.0 | 90.6 | 87.8 | 85.0 |
| preheat | | | | | | | | |
| (° C.) | | | | | | | | |
| TDO | 79.4 | 79.4 | 76.7 | 82.2 | 79.4 | 87.8 | 82.2 | 79.4 |
| stretch (° C.) | | | | | | | | |
| TDO | 75.0 | 75.0 | 75.0 | 75.0 | 75.0 | 75.0 | 75.0 | 75.0 |
| anneal (° C.) | | | | | | | | |
| Clarity | 69.4 | 70.2 | 71.8 | 69.6 | 63.3 | 68.4 | 66.2 | 67.9 |
| Gloss | 108 | 108 | 92 | 90 | 82 | 92 | 92 | 92 |
| Haze | 2.2 | 2.5 | 5.5 | 6.9 | 9 | 6 | 7.2 | 5.2 |

TABLE 3

| Sample | | | | | | |
|---|---|---|---|---|---|---|
| 17 | 18 | 19 | 20 | 21 | 22 | 23 |

Layer Composition (component—wt. %):

| | | | | | | | |
|---|---|---|---|---|---|---|---|
| A | SBS2- | SBS2- | SBS2- | SBS2- | SBS2- | SBS2- | SBS2- |
| | 81.5% | 81.5% | 81.5% | 81.5% | 86.5% | 86.5% | 87% |
| | PS1- | PS1- | PS1- | PS1- | PS1- | PS1- | PS1- |
| | 15.0% | 15.0% | 15.0% | 15.0% | 10.0% | 10.0% | 10.0% |
| | MB1- | MB1- | MB1- | MB1- | MB1- | MB1- | MB1- |
| | 3.5% | 3.5% | 3.5% | 3.5% | 3.5% | 3.5% | 3.0% |
| B | EMA1- | EMA1- | EOA1- | SBS3- | EMA1- | EMA1- | EMA1- |
| | 85% | 85% | 90% | 100% | 85% | 85% | 85% |
| | SEBS1- | SEBS1 | SBS3- | | SEBS1- | SEBS1- | SEBS1- |
| | 15% | -15% | 10% | | 15% | 15% | 15% |
| C | EAO1- | EAO1- | EAO1- | EAO1- | EAO1- | EAO1- | EAO1- |
| | 90% | 90% | 90% | 90% | 100% | 100% | 100% |
| | SBS3- | SBS3- | SBS3- | SBS3- | | | |
| | 10% | 10% | 10% | 10% | | | |
| Density (g/cc) | | | | | 0.945 | 0.947 | |
| Extrudate | 12.2 | 12.2 | | 12.2 | 12.2 | 12.2 | 12.2 |
| Film | | | | | | | |
| Thickness | | | | | | | |
| (mils) | | | | | | | |
| Final Film | 50 | 50 | | 50 | 50 | 50 | 50 |
| Thickness | | | | | | | |
| (micron) | | | | | | | |

Layer weight % relative total film:

| | | | | | | |
|---|---|---|---|---|---|---|
| A (each) | 6.9% | 6.9% | 15.3% | 15.3% | 13.1% | 15.4% |
| B (each) | 7.9% | 7.9% | 10.2% | 10.2% | 10.0% | 9.7% |
| C | 70.3% | 70.3% | 49.0% | 49.0% | 53.8% | 49.7% |

Transverse direction (TD) free shrink %

| | | | | | |
|---|---|---|---|---|---|
| @80° C. | 58 | 52 | 49 | 45 | 59 |
| @90° C. | 74 | 73 | 70 | 70 | 75 |

Machine direction (MD) free shrink % (negative number indicates expansion)

| | | | | | | |
|---|---|---|---|---|---|---|
| @80° C. | 0 | −3 | −5 | −4 | 0 | |
| @90° C. | −1 | −4 | −6 | −5 | −1 | |
| TDO preheat | 87.8 | 85.0 | 90.6 | 87.8 | 87.8 | |
| (° C.) | | | | | | |
| TDO stretch | 82.2 | 79.4 | 85.0 | 82.2 | 81.1 | |
| (° C.) | | | | | | |
| TDO anneal | 75.0 | 75.0 | 75.0 | 75.0 | 90.6 | |
| (° C.) | | | | | | |
| Clarity | 65.3 | 64.1 | 66.8 | 74.1 | 74.9 | 73 |
| Gloss | 94 | 92 | 93 | 104 | 105 | 99 |
| Haze | 7.9 | 8.2 | 7.9 | 3 | 3 | 6.8 |

Sample 19 failed to have sufficient integrity to establish a complete web under the processing conditions during the orientation step upon exiting the tenterframe oven.

Samples 21, 22, and 23 were made into shrink sleeves by solvent seaming using a using a Karville seamer and a solvent available from Flexcraft, Inc. under the 10-20G trade name. The resulting shrink sleeves were successfully shrunk in a stream tunnel to apply to bottles with no delamination at the seam or anywhere else.

It was surprising and unexpected that films having an intermediate layer having SEBS in an amount of at most 50%, down to as low as at most 12%, by weight of the intermediate layer could be made successfully without delamination and to free shrink by at least 65% without delamination at 90° C. in at least one of the transverse and machine directions.

### Samples 24 to 25

Five-layer films (Samples 24 and 25) were made by extruding an extrudate film having an A/B/C/B/A film layer configuration where the “A” skin layers, the “B” intermediate layers, and the “C” base layer had the compositions shown in Table 4.

The extrudate film was extruded using four extruders and a feedblock configured above a die to form the relatively thick extrudate film having the thickness shown in the tables. The extrudate film was then preheated, and oriented using a tenterframe machine only in the transverse direction at a orientation ratio of 6.2:1. The resulting oriented film was annealed for a relatively short time and then allowed to cool to ambient temperature. The temperatures of the preheat, orientation, and anneal are shown in the tables. The thickness of the oriented film is also shown in the tables, as well as the other properties of the oriented film.

TABLE 4

Sample

| | |
|---|---|
| 24 | 25 |

Layer Composition (component - wt. %):

| | | |
|---|---|---|
| A | SBS2 - 87.0% | SBS2 - 87.0% |
| | PS1 - 10.0% | PS1 - 10.0% |
| | MB1 - 3.0% | MB1 - 3.0% |
| B | EMA1 - 85% | EMA1 - 80% |
| | SEBS1 - 15% | SEBS1 - 20% |
| C | EAO1 - 100% | EAO1 - 100% |
| Density (g/cc) | 0.950 | 0.950 |
| Extrudate Film | | |
| Thickness (mils) | 12.2 | 12.2 |
| Final Film | | |
| Thickness (micron) | 50 | 50 |

Layer weight % relative total film:

| | | |
|---|---|---|
| A (each) | 20.3% | 20.3% |
| B (each) | 8.3% | 8.3% |
| C | 42.8% | 42.8% |

Transverse direction (TD) free shrink %

| | | |
|---|---|---|
| @80° C. | 52 | 53 |
| @90° C. | 70 | 71 |

Machine direction (MD) free shrink %
(negative number indicates expansion)

| | | |
|---|---|---|
| @80° C. | −3 | −5 |
| @90° C. | −3 | −5 |
| TDO preheat (° C.)* | 70 to 90 | 70 to 90 |
| TDO stretch (° C.)* | 83 to 86 | 83 to 86 |
| TDO anneal (° C.) | 78 | 78 |
| Haze | 3.2 | 3.2 |

*There were five preheat zones and six stretch zones. The reported temperatures are the range of temperatures over those zones.

Sample 24 (having 15% SEBS1 in the intermediate layer) was successfully oriented; however, the some of the representative samples of the oriented film delaminated in the shrink bath during testing to establish the amount of free shrink. Sample 25 (having 20% SEBS1 in the intermediate layer) was successfully oriented and all of the representative samples of the oriented film did not delaminate in the shrink bath during testing to establish the amount of free shrink.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

1. A film comprising:
a skin layer comprising at least 50% by weight of the skin layer of styrenic block copolymer having a styrene monomer content of at least 50 wt. %;
a base layer comprising at least 50% by weight of the base layer of ethylene/alpha-olefin copolymer; and
an intermediate layer between the skin and base layers and directly adjacent at least one of the skin layer and the base layer, the intermediate layer comprising at least 12% and at most 50%, by weight of the intermediate layer, of styrene/ethylene-butadiene/styrene block copolymer, wherein the film has:
a free shrink at 90° C. in at least one of the transverse and machine directions of at least 65%; and
a density of at most 0.960 grams per cubic centimeter.

2. The film of claim 1 wherein the film has a density of at most 0.950 grams per cubic centimeter.

3. The film of claim 1 wherein the film has a free shrink at 90° C. in at least one of the directions of at least 70%.

4. The film of claim 1 wherein the film has a free shrink at 90° C. in one of the transverse and machine directions of at most −2%.

5. The film of claim 1 wherein the ethylene/alpha-olefin copolymer has a density of at most 0.900 grams per cubic centimeters.

6. The film of claim 1 wherein the intermediate layer is directly adjacent the skin layer.

7. The film of claim 1 wherein the intermediate layer is directly adjacent the base layer.

8. The film of claim 1 wherein the intermediate layer comprises at most 30%, by weight of the intermediate layer, of styrene/ethylene-butadiene/styrene block copolymer.

9. The film of claim 1 wherein the intermediate layer comprises at most 25%, by weight of the intermediate layer, of styrene/ethylene-butadiene/styrene block copolymer.

10. The film of claim 1 wherein the intermediate layer comprises at least 15%, by weight of the intermediate layer, of styrene/ethylene-butadiene/styrene block copolymer.

11. The film of claim 1 wherein the intermediate layer comprises at least 18%, by weight of the intermediate layer, of styrene/ethylene-butadiene/styrene block copolymer.

12. The film of claim 1 wherein the intermediate layer comprises at least 20%, by weight of the intermediate layer, of styrene/ethylene-butadiene/styrene block copolymer.

13. The film of claim 1 wherein the styrene/ethylene-butadiene/styrene block copolymer comprises styrene monomer content of at least any one of 12 mole % and at most 25 mole %.

14. The film of claim 1 wherein the styrene/ethylene-butadiene/styrene block copolymer comprises a styrene block to rubber block mole to mole ratio of at least any one of 10:90 and at most 30:70.

15. The film of claim 1 wherein the intermediate layer further comprises at least 50% by weight of the intermediate layer of ethylene/unsaturated ester copolymer.

16. The film of claim 1 wherein the intermediate layer comprises at least 60% by weight of the intermediate layer of ethylene/C₁-C₁₂ alkyl (meth)acrylate copolymer.

17. The film of claim 1 wherein the styrenic block copolymer of the skin layer comprises styrene/butadiene copolymer.

18. The film of claim 1 wherein the skin layer further comprises at least 0.5% and at most 30%, based on the weight of the skin layer, of polystyrene having a styrene monomer content of at least 90 weight %.

19. The film of claim 1 wherein the skin layer comprises at least 75% of the styrene block copolymer, based on the weight of the skin layer.

20. The film of claim 1 wherein:
the skin layer weighs at least 5% and at most 20%;
the intermediate layer weighs at least 5% and at most 20%; and
the base layer weighs at least 40% and at most 80%;
wherein the percentages are based on the total weight of the film.

21. The film of claim 1 wherein:
the skin layer weighs at most 15%;
the intermediate layer weighs at most 10%; and
the base layer weighs at least 50%;
wherein the percentages are based on the total weight of the film.

22. The film of claim 1 wherein:
the skin layer is a first skin layer;
the intermediate layer is a first intermediate layer; and
the first intermediate layer is between the first skin layer and the base layer; and further comprising:
a second skin layer substantially similar to the first skin layer; and
a second intermediate layer substantially similar to the first intermediate layer, wherein the second intermediate layer is between the second skin layer and the base and is directly adjacent at least one of the second skin layer and the base layer.

23. A method of making the film of claim 1, the method comprising:
extruding an extrudate film comprising the skin, intermediate, and base layers, wherein the extrudate film has an original given dimension in a given direction;
stretching the extrudate film by a stretching ratio of at least five times the original given dimension in the given direction at a stretching temperature of at most 85° C.

24. The method of claim 23 wherein the stretching ratio is at least six times the original given dimension in the given direction.

25. The method of claim 1 wherein the stretching is made in only one direction.

26. The method of claim 1 wherein the stretching temperature is at most 83° C.

27. The method of claim 1 wherein the stretching temperature is at most 80° C.

28. The method of claim 1 further comprising annealing the stretched extrudate film at an annealing temperature of at least 70° C.

29. A shrink sleeve comprising the film of claim 1.

30. A method of labeling a container comprising:
placing the shrink sleeve of claim 29 around the container; and
shrinking the shrink sleeve to conform the shrink sleeve to the container.
